(19) United States
(12) Patent Application Publication
(10) Pub. No.: US 2020/0402136 A1
(43) Pub. Date: Dec. 24, 2020

(54) Avatar Matching in On-Line Shopping

(71) Applicant: SEDDI, INC., New York, NY (US)

(72) Inventor: Graham SULLIVAN, New York, NY (US)

(73) Assignee: SEDDI, INC., New York, NY (US)

(21) Appl. No.: 16/960,465

(22) PCT Filed: Feb. 14, 2019
(86) PCT No.: PCT/US19/17972

§ 371 Date: Jul. 7, 2020

Related U.S. Application Data
(60) Provisional application No. 62/635,187, filed on Feb. 26, 2018.

(51) Int. Cl. G06Q 30/06; G06Q 10/08; G06F 16/9535

(52) U.S. Cl. CPC G06Q 30/0631; G06Q 30/0643; G06F 16/9535; G06Q 10/087; G06Q 30/0623; G06Q 30/0635

(57) ABSTRACT

Methods and systems for suggesting merchandise to a shopper are based on a match between a portion of a three-dimensional (3D) avatar representing the shopper that is relevant to the merchandise, and the corresponding portion of a 3D fit avatar used by a designer and/or manufacturer to create the merchandise or associated with the merchandise by the designer and/or manufacturer.

### CROSS-REFERENCE TO RELATED APPLICATIONS

This application claims priority to U.S. Provisional Patent Application No. 62/635,187 filed on Feb. 26, 2018, the contents of which are incorporated herein by reference in their entirety.

### BACKGROUND

Embodiments relate to on-line shopping, and more specifically to suggesting merchandise to a shopper based on a match between a portion of a three-dimensional (3D) avatar representing the shopper that is relevant to the merchandise, and the corresponding portion of a 3D fit avatar used by a designer and/or manufacturer to create the merchandise or associated with the merchandise by the designer and/or manufacturer.

### BRIEF DESCRIPTION OF THE DRAWINGS

The subject matter which is regarded as the invention is particularly pointed out and distinctly claimed in the claims at the conclusion of the specification. The features and advantages of the invention are apparent from the following detailed description taken in conjunction with the accompanying drawings in which:

FIG. 1 depicts a block diagram of components utilized by an on-line shopping system in accordance with one or more embodiments where three-dimensional (3D) shopping and fit avatars are matched before consumer selection criteria is applied;

FIG. 2 depicts a block diagram of components utilized by an on-line shopping system in accordance with one or more embodiments where consumer selection criteria is applied before 3D shopping and fit avatars are matched;

FIG. 3 depicts a flow diagram of a consumer process for on-line shopping in accordance with one or more embodiments;

FIG. 4 depicts a flow diagram of a retailer process for on-line shopping in accordance with one or more embodiments; and

FIG. 5 depicts a block diagram of a system for on-line shopping in accordance with one or more embodiments.

### SUMMARY

According to embodiments of the disclosure, computer-implemented methods, systems, and computer program products are provided for identifying merchandise items, such as doting. In embodiments, selection criteria is received, form example from a shopper, as well as a shopping avatar of the shopper. Any relevant portions of the shopping avatar are identified based on the selection criteria. A fit avatar that includes portions corresponding to the relevant portions of the shopping avatar that are within a threshold of matching the relevant portions of the shopping avatar are located. Merchandise items that were designed or manufactured based on the located fit avatar are identified. From those merchanides items, a subset of them are presented to the shopper. The subset includes the identified merchandise items that satisfy the selection criteria. A request to purchase at least one of the subset of the identified merchandise items is then received, processed, and the subset of the identified merchandise items are sent to the shopper. In other embodiments, a shopping avatar may be created for the user. Selection criteria regarding a merchandise item for the user is also received. Then, a plurality of merchandise items that satisfy the selection criteria and that were designed or manufactured using fit avatars having relevant portions that are within a threshold of matching corresponding portions of the shopping avatar are identified. The relevant portions are selected based on the selection criteria. Then the merchandise items may be viewed via a user interface of a computer. Based on selecting some merchandise items for purchase, the selected merchandise items are purchased. Also, based on selecting some merchandise items for storage in a virtual closet, a representation of the merchandise items selected for storage are stored in the virtual closet.

In some embodiments, locating a fit avatar that includes portions corresponding to the relevant portions of the shopping avatar that are within a threshold of matching the relevant portions of the shopping avatar or identifying the plurality of merchandise items may include comparing the relevant portions of the shopping avatar with an equivalent relevant portions from a plurality of fit avatars.

In some embodiments, locating the fit avatar or identifying the plurality of merchandise items may be based on at least one of a downstream fit-to-fit matching measurement, a manufacturer default rule, a manufacturer modification to a merchandise item due to a change in a manufacturing process.

In some embodiments, the selection criteria may include at least one or more of a color preference, a price range, or a fabric.

According to the various embodiments, a system may include a memory having computer readable instructions and a processor for executing the computer readable instructions.

### DETAILED DESCRIPTION

Embodiments described herein are directed to assisting an on-line shopper in finding merchandise, such as clothing, that is most likely to fit the shopper. Portions of a three-dimensional (3D) shopping avatar(s) that reflect the body shape of the shopper and that are relevant to the merchandise being searched for are compared to those portions of 3D fit avatars that represent or approximate the fit models used by a designer or manufacturer in creating the clothing or other merchandise offered for sale by the retailer. Based on this comparison, clothing items that were created using the relevant portions of the 3D fit avatars that most closely match the corresponding portions of the 3D shopping avatar are presented to the on-line shopper for purchase. The items presented to the shopper can be further narrowed down based on selection criteria entered by the shopper, such as color or type of clothing.

Fit is ultimately a subjective term that describes whether a particular garment, shoe or some other item put in proximity of the human body supports its purpose with sufficient satisfaction to be in a zone of acceptable fit. Purposes are endless and the judgment of “fit” is ultimately in the eye of the beholder, that is, the owner of the body or some other person(s). A model may not like an outfit he or she is wearing and yet the designer may like the fit (and look) achieved by the outfit.

One way for a shopper to determine fit is to physically try on a garment (or other item) in order to evaluate the feel of the clothing on their body and the look created by the drape, textures, colors, and quality of the clothing on the body. Regardless of any “size” attribute associated with the clothing or other items, the experience of the actual item, often along with feedback from others, drives the evaluation by the shopper.

A shopper may attempt to determine fit based on a size assigned to an item. Sizes are often arbitrary and described in relative terms which are not tied to a common measurement system. For certain items, the use of actual units of measure can be used to determine dimensions of a human shape. For clothing designers, reasonable assumptions about the rest of the body's shape being roughly proportional to those measurements can be made when designing garments. A breakdown of the relative sizing systems are often seen in women's sizes where the practice of vanity sizing makes the sizing uncertain at best. In practice, women experience the sizing practices of each brand whose clothing and price points appeal to them and learn what sizes, if any, “fit” them. Many women simply stick to the brands that “work” for them. This uncertainty about sizing/fit can diminish shopper exploration. In brick and mortar stores, this impact can be overcome in part by store personnel encouraging women to try on items from new brands in order to add to the portfolio of choices of what works.

In on-line shopping, these issues of uncertainty about sizing and fit can become nearly untenable. According to an estimate by The California Fashion Association, 34% of all on-line purchases are returned. Because shoppers do not return all merchandise that does not fit or look right, the percentage of on-line shoppers not completely satisfied with their purchase is likely over 50%. Informed only by pictures featuring models and uncertain sizing, the consumer is faced with a purchasing decision knowing there is a significant likelihood that the purchase will be unsatisfactory.

One or more embodiments described herein replicate, in an on-line shopping experience, as many components of physically trying on a garment as possible. One component is the physical experience of the actual garment. To recreate the physical experience, embodiments create a soft tissue shopping avatar(s) which represents the form, or body shape, of the shopper. As used herein, the term “soft tissue” refers to the avatar having simulated flesh that moves when subjected to the pressure of clothing and gravity. The shopping avatar represents the form of the person who will experience the garment, possibly while wearing other garments, such as underwear, a bra, a shape forming garment, an under layer, etc. The shopping avatar represents what the shopper would look like in a dressing room when the shopper takes off what he or she came in wearing to try on a new garment. One shopper can have multiple shopping avatars depending on what undergarments or base garments the shopper is planning on wearing with the garment. In addition, a shopping avatar may represent all, or a portion of the shopper's body The shopping avatar can be custom made or created in any manner known in the art. For example, there exist, on-line, various avatar templates, that may or may not be open source (or otherwise offered without commercial license), and they may also be available from various online virtual worlds, such as Second Life. Additionally, a shopper can, for example, enter into an on-line form, body measurements (with or without undergarments) manually taken by the shopper, or another party, with a measuring device such as a tape measure. A computing device can then render those measurements into a custom online shopping avatar. Additionally a shopper may enter body measurement data resultant from a third party measuring system. Examples of third party measurement systems include systems where a fixed or moving camera(s) takes images at multiple angles vis-a-vis the shopper's own body. Distances, such as from the edge of the image to a particular same point on the subject shopper's image, can be measured and compared among the various multi-angled images of the shopper. Geometric and algorithmic mathematical models utilizing the above referenced distances can then be employed by a computing device to determine the shopper's body measurements. The shopper can then manually enter the resultant body measurements into an on-line form, or the shopper's body measurements can be transmitted electronically from the computing device to another computing device (possibly the same system) where the shopper's body avatar is created utilizing various mathematical algorithmic means. Alternatively, shoppers may avail themselves of a third party measuring booth, such as are employed at, for example, some department stores. In a third party measuring booth, various means such as, but not limited to laser and radar are utilized to mathematically map the shopper's body, from a plurality of angles (e.g. to perform a “3D scan”). The resultant map data set can then be utilized by a computing device to create a shopper's avatar.

Once the shopping avatar is created, its dimensions can then be matched to garment manufacturer fit model dimensions, and based on the matching, a selected fit-matched new garment can be presented electronically to the shopper. Not all avatars are an accurate representation of the current dimensions of a given shopper. A shopper may, for any number of reasons, have multiple shopping avatars. For example, a shopper may have among their plurality of avatars, an aspirational avatar, representing what the shopper may look like after they start working out and losing a certain number of pounds. Additionally, on-line avatar maintenance tools exist to reflect various factors, such as weight gain or loss, or the changing dimensions of a pregnant woman.

A selected new garment can then be combined, or put on, the shopping avatar and the interaction modeled. To get a good idea of fit, the effect of the shopper's body on the garment and the garment on the shopper's body are modeled together with gravity, and the results are graphically rendered. The final resulting rendering can then be presented to the shopper, or consumer, for evaluation. The rendering can be performed and presented using any manner known in the art such as, but not limited to, that described in United States Patent Publication Number US2011/0246329A1 which describes a motion based interactive shopping environment, or that described in United States Patent Publication Number US2014/0176565A1 which describes generating virtual body models for garment fit visualization, and/or that described in United States Patent Publication Number US2009/0144173A1 which describes a static method for virtual clothes coordination on a 3D avatar, all of which are hereby incorporated by reference in their entirety.

One or more embodiments described herein are focused on helping the on-line shopper identify garments to try on their shopping avatar(s) that represent their body size and shape. Trying every garment that satisfies a particular set of search text terms, or selection criteria, is possible but can be computational impractical. One or more embodiments described herein utilize a novel approach to the identifying of garments by searching for garments that should fit a consumer (also referred to herein as a “shopper”) sufficiently well to be worthy of the consumer viewing the choice for visual evaluation on the avatar. In other words, a search is conducted that combines knowledge of the consumer's avatar measurements with search terms to down select or filter the choices returned to the consumer.

Embodiments described herein are rooted in the recognition that a real marketplace of 3D garments will contain literally hundreds of millions of garments in the future, and that it will be extremely difficult, if not impossible, for a shopper to find what he or she wants quickly. In accordance with one or more embodiments, a shopper may be presented with garment choices based on comparing the relevant portions of a shopping avatar to the corresponding portions of fit avatars. Additional selection criteria may also be utilized to further narrow down or filter the garment choices.

Contemporary methods of producing garments, or 3D garments, for consumers include assembling (sewing together) the garments from two-dimensional (2D) patterns which can be designed in computer aided design (CAD) software and/or digitized from paper patterns. The 2D patterns are assembled around a fit avatar which is often derived from a body scan of live fit model. There are companies that offer fit avatars that represent various regional and ethnic populations or that develop them specially for particular brands, again often based on live fit models. Examples of these companies include, but are not limited to: Alvanon, Inc.; Optitex Ltd; and CLO Virtual Fashion, Inc. 2D patterns and 3D clothing models developed from these patterns are graded, that is, the various sizes are created for the garment. In one or more embodiments, fit avatars are associated with each garment size, and may include various interactive methods to resize the fit avatar. Fit avatars may also be graded vis-a-vis a plurality of additional factors, such as undergarments and/or shape forming garments.

Clothing manufacturers often rely on live fit models, that is, live human beings who are professional models that represent various industry standard sizes, such as “42 Regular.” For example, Clothing Manufacturer #1 creates a physical “42 Regular” pattern for a particular piece of clothing based upon the dimensions of a live human being fit model. Clothing Manufacturer #2 also creates their “42 Regular” pattern from a different live human being fit model. However, the live human being fit models for these two clothing companies may very well have differing body dimensions. Thus, clothes graded from Clothing Manufacturer #1's 42 Regular pattern may differ in size from those graded from Clothing Manufacturer #2's 42 Regular pattern, and thus, while being labeled with the same size, each will fit a shopper's body differently. Additionally, clothing manufacturing companies may utilize a live human being fit model to create the 42 Regular avatar for that company. Thus, the 42 Regular avatar for Clothing Manufacturer #1 may differ from the 42 Regular avatar for Clothing Manufacturer #2. Thus, when clothes from Clothing Manufacturer #1 are mapped onto a user's shopping avatar, they may appear to fit differently than those mapped onto a user's shopping avatar from Clothing Manufacturer #2. The aforementioned practices may result in customers ordering clothes that they ultimately end up returning for reasons of improper fit.

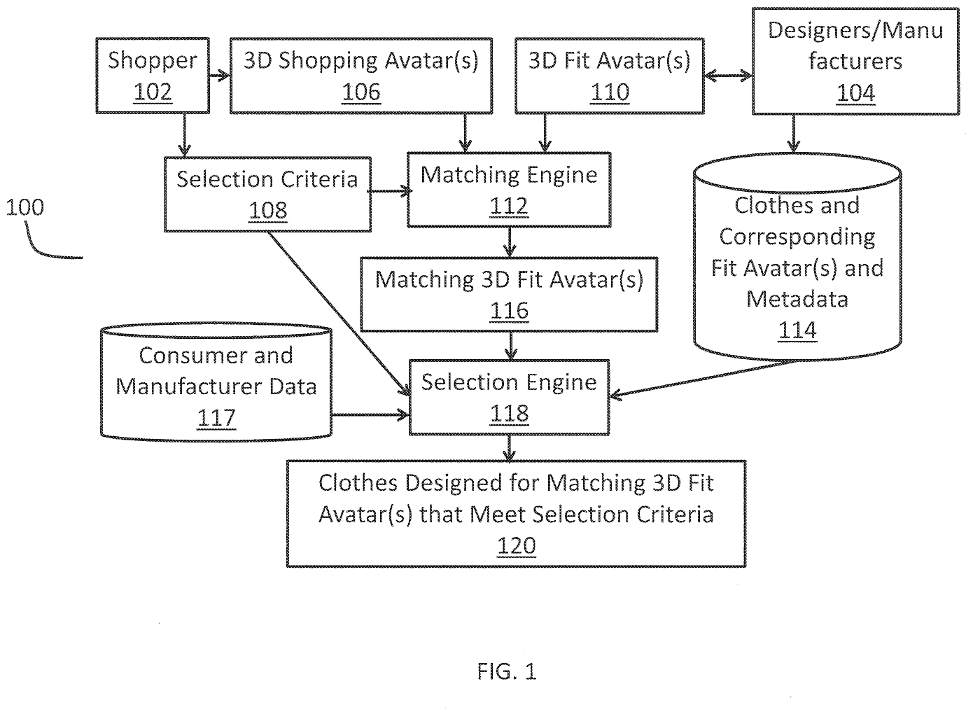

Additionally, prior to manufacturing, the dimensions of a fabric pattern created from a live human being fit model, are often changed by the manufacturing department to fit pre-existing manufacturing machines, lines, and/or sizes. Thus, even more size variability within a given “size” label (e.g., 42 Regular) is introduced. One or more embodiments described herein provide a method of creating fit avatars based directly off of the final manufacturing patterns, as rendered by the CAD/CAM machines being utilized to actually manufacture any particular garment. Thus, when a shopper's fit avatar dimensions are matched against actual manufacturing size data from the clothing maker's fit avatar, the customer is presented with garment choices that have a higher likelihood of fitting, likely resulting in a lower return rate. In accordance with one or more embodiments, such as that shown in FIG. 1 below, fit avatars are down selected using the body portions from the shopping avatar that correspond to the type of item being selected. For example, if the shopper is looking to purchase slacks, then then the portion of a shopping avatar from the waist down is matched to the portion of the fit avatars from the waist down. In one or more embodiments one or both the shopping and fit avatar may only represent a portion of a body from the waist down. In another example, if the shopper is looking to purchase a ring, then the finger portion of the shopping avatar (which may be the whole shopping avatar) is compared to the finger portion of a fit avatar. The fit avatar in this case could be a hand or just a cylinder representing the size of a finger. Once the matching fit avatars have been selected, additional search criteria (e.g., color, style, fabric, etc.) specified by the shopper can be applied to narrow down (or down select) the number of selections presented to the shopper. In this example, only those items that are likely to fit shopper will be displayed. Referring now to FIG. 1, a block diagram 100 of components utilized by an on-line shopping system are generally shown in accordance with one or more embodiments where selection criteria from a shopper are used to search for and find candidate clothes or other merchandise. Portions of the shopper's body relevant to the selection criteria are identified, and those portions of the 3D shopping avatars 106 and 3D fit avatars 110 are compared. When the comparison is close enough, i.e., the measurements associated with the relevant portions of the body are within a system or user specified tolerance, then the items associated with the fit avatar 110 are candidate clothes for the shopper. In the embodiment shown in FIG. 1, the merchandise is clothing. As shown in FIG. 1, the on-line shopping system has access to 3D fit avatars 110 that were used to represent the fit models by a designer and/or manufacturer 104 in designing the clothes, and used (e.g., by the designer and/or manufacturer 104) to generate the patterns for making the clothing in various sizes. The system also has access to a database 114 that stores digital representations of the clothes offered for sale by an on-line retailer and identifies their corresponding fit avatar(s) that were used to generate the patterns for creating the clothes as well as metadata about the clothing. Digital representations may simply be pictures of the clothing or other merchandise. Metadata for each element or grouping of clothing may be assigned in a variety of manners with different parties supplying different types of metadata. For example, metadata provided by the manufacturer may include the origins of a particular garment or fabric, search terms to help shoppers find a particular garment, obsolescence information (which may include the knowledge that a particular garment is no longer available, but has now been replaced by a different garment), suggestions for complimentary items of clothing, and knowledge as to shrinkage of a garment when washed a number of times, based upon research and development (R&D) data from the manufacturer. The metadata may also include comments by consumers collected over time.

The on-line shopping system shown in FIG. 1 also has access to one or more 3D shopping avatars 106 that were created by or for the shopper 102 and that represent the body of the shopper 102, or a portion thereof. The relevant portions of the shopping avatar are determined from the selection criteria 108 entered by the user which can include but is not limited to: a type of clothing (shirt, slacks, etc.) or other merchandise. The matching engine 112 shown in FIG. 1 searches for the 3D fit avatars 110 whose corresponding portions “match” the 3D shopping avatar(s) 106. The matching engine 112 outputs the matching 3D fit avatars 116, for which there may correspond a large numbers of clothing items. The clothes suggested by the system can be further restricted by the selection criteria 108 entered by the user, which can further include (along with type of clothing or other merchandise), but is not limited to: color preferences, preferred price range, and fabric. As shown in FIG. 1, a selection engine 118 in the system receives the selection criteria 108, the matching 3D fit avatars 116, and the database 114 of clothes, their corresponding fit avatars, and metadata about the clothes. In one or more embodiments the selection criteria 108 is entered by the shopper 102, while in one or more other embodiments the selection criteria 108 is entered or modified automatically by the system based on the shopper's profile, past shopping history of the shopper 102, and/or based on retailer input (e.g., to include items they want to sell quickly, etc.) or in any other manner.

Also shown in FIG. 1, is a database 117 that includes consumer and manufacturer data that can also be input to the selection engine 118. The database 117 can include downstream fit-to-fit (consumer-to-manufacturer) matching measurements, threshold setting criteria and limits, manufacturer default rules, any modifications that the shopper may make in their preferences including “fit” preferences, and/or any modifications the manufacturer may make due to various changes such as manufacturing line re-tooling, supplier fabric changes, or relevant commodity price changes. For example, a shopper may set their preference to round up to the next standard waist size, if their shopping avatar is between two standard manufacturer sizes.

Still referring to FIG. 1, the selection engine 118 narrows the choices presented to the shopper 102 based on the meta-data and selection criteria 108 (and optionally on the contents of database 117), and outputs clothing suggestions 120 that include clothing that meet the selection criteria 108 and that correspond to the matching 3D fit avatars 116. The clothing suggestions 120 output by the system have a high likelihood of fitting the shopper 102. If a 3D model for the clothes is available, the clothes can be presented to the shopper 102 overlaid on a 3D shopping avatar(s) 106 and/or on a 3D fit avatar 110, otherwise a digital representation such as a picture of the merchandise may be presented. The system can also allow the shopper to select clothing for consideration at a later time, save to a virtual closet, purchase, order the clothing, and pay for the clothing. In addition, the system can interface with a retailer or clothing manufacturer to place the order and cause the clothing to be sent to the shopper.

In accordance with one or more embodiments, the entry and application of the selection criteria by the selection engine 118 is optional. For example, an on-line retailer that has a limited number of clothing selections may present all clothing items that have fit avatars 116 with the relevant portions that match the corresponding portions of the 3D shopping avatar of the shopper.

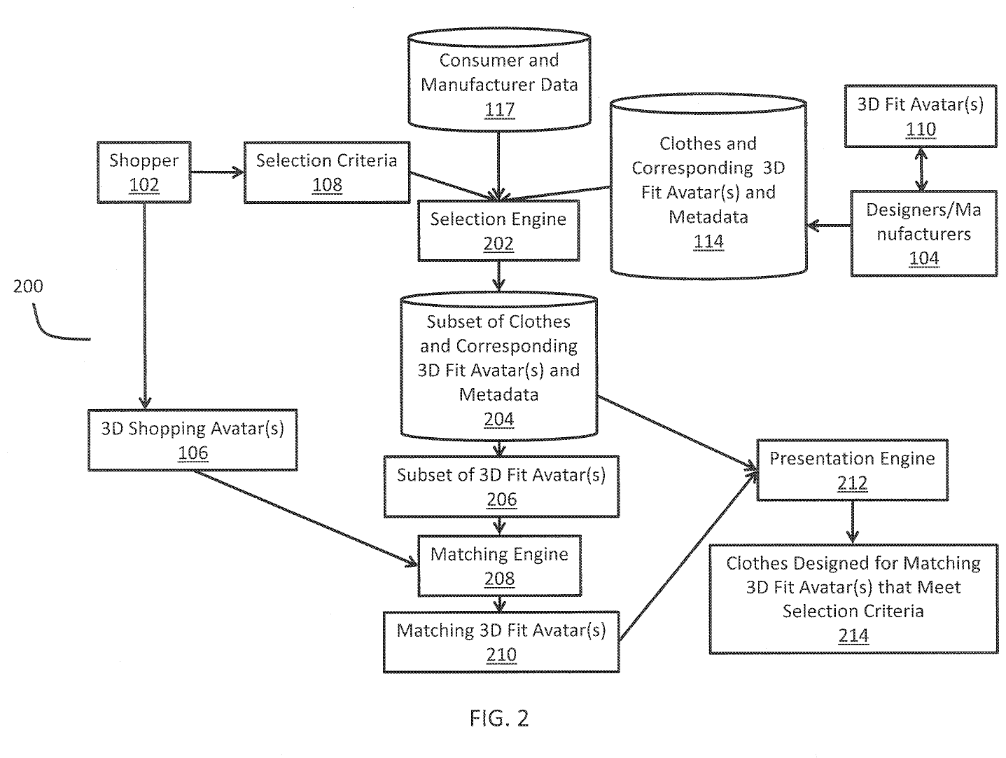

In accordance with one or more embodiments, such as that shown in FIG. 2 below, merchandise choices are down selected using the selection criteria entered by the shopper. For example, if based on the selection criteria, it is determined that the shopper is looking to purchase a pair of black jeans, then all black jeans are identified in the database 114. Once the items fitting the selection criteria are identified, the relevant portions of the fit avatars associated with the identified items are matched to the relevant portions of the shopper's avatar to narrow down the choices to just those items that are likely to fit the shopper. In this example, the relevant portions can be the measurements from the waist down. The narrowed down choices are presented to the shopper for consideration. In one or more embodiments, products in the database that are similar to the selection criteria can also be identified and presented to the user, in this example this may include dark jeans, black slacks of particular fabrics, etc.

Turning now to FIG. 2, a block diagram 200 of components utilized for avatar matching in an on-line shopping system are generally shown in accordance with one or more embodiments where the selection criteria are used to search for and find candidate clothes or other merchandise. In the embodiment shown in FIG. 2, candidate garments are located by first identifying a group of garments using selection criteria 108, such as text search terms, entered by the shopper 102. Each of the candidate garments has an associated 3D fit avatar 110. Portions of the body relevant to the search criteria are identified and those portions of the 3D shopping avatar 106 are compared to the 3D fit avatar 110. When the comparison is close enough, i.e., the measurements associated with the relevant portions of the body are within a system or user specified tolerance, then the items associated with the 3D fit avatar 110 are candidate clothes for presentation to the shopper. The embodiment shown in FIG. 2 can be used, for example, by on-line retailers with a large inventory of clothing to reduce computer resource use by only performing the 3D avatar matching on a subset of the inventory.

Similar to the system shown in FIG. 1, the system in FIG. 2 includes the shopper 102, the 3D shopping avatar(s) 106, the selection criteria 108, database 114, database 117, the designers and/or manufacturers 104, and the 3D fit avatars 110. The selection engine 202 narrows the choices presented to the shopper 102 based on the selection criteria 108 using, for example, metadata corresponding to the clothing in the database 114. The selection engine 202 outputs a subset database 204 (or identifies records in database 114), that includes the subset of the clothing items in the database 114 that meet the selection criteria 108.

The matching engine 208 shown in FIG. 2 searches for the relevant portions of the 3D fit avatars 110 in the subset database 204 that match the relevant portions of the 3D shopping avatar(s) 106 in a manner similar to that described above with respect to FIG. 1. The matching engine 208 outputs the matching 3D fit avatars 210 which are then input to the presentation engine 212 along with the subset database 204 to select the clothing that corresponds to the matching 3D fit avatar(s) 210. In this manner, the presentation engine 212 outputs clothing suggestions 214 that include clothing that meet the selection criteria 108 and that have a high likelihood of fitting the shopper 102.

In accordance with one or more embodiments, rather than presenting each garment as a candidate with a subsequent need to still figure which graded size might fit the consumer avatar, a set of consumer avatar measurements extracted from the 3D shopping avatar are compared to the same set of measurements on the graded 3D fit avatars. The number of measurements required for comparison can be relatively small and using a subset of the measurements for comparison can greatly reduce the computational requirements for a search. Each garment's “fit” is governed generally by a subset of an avatar's measurements. It is the subset to subset comparison that produces the evaluation of the fit. An example is a shirt, where the relevant measurements subset is the torso. In this example, the same shirt might fit both a person who is 6′3″ and someone who is 5′8″ so choosing a relevant subset is important. Relevant subset selection may be achieved in a variety of different manners, such as, but not limited to ranking various pattern elements. When shopping for a short sleeve t-shirt, it may be the case for a particular shopper, that the length of the chest and back pattern fields is the most important, and thus a top-ranked dimension. And it may well be the case that the length of the short sleeve pattern element is the lowest ranked criteria. Such criteria and ranking can be created by either or both the shopper and/or the clothing manufacturer, and generated via, for example, online surveys, or in-person focus groups, or other of a plurality of means.

One or more embodiments described herein utilize matching algorithms that evaluate the various differences between the corresponding portions of the 3D fit and shopping avatars using the subset of measurements appropriate for the portions of the body associated with each garment family that sufficiently qualify or disqualify fit avatars for further evaluation. Disqualification of a fit avatar means any garments associated with the fit avatar are also disqualified, hence further reducing the possible search results to be returned to the shopper. An example is searching for men's distressed straight leg blue jeans. A shopper's shopping avatar with a 38″ waist and 34″ inseam will not match any of the fit avatars for the jeans line whose largest size is 34″ waist and 34″ inseam because the pant family default rules might read: shopping avatar waist must be +0.5″/−1.0″ of fit avatar waist; and shopping avatar inseam must be +/−0.5″ of fit avatar inseam. In this example, the shopping avatar has the same inseam length as the fit avatar for longest length jeans but the waist is too large. There is no other larger fit avatar for this jeans line so there is no need to return any item from this line in the search. If the shopper's shopping avatar has a 31.75″ waist and 33.5″ inseam, then a candidate match will be generated with the fit avatar with the 32″ waist and 34″ inseam. In one or more embodiments, the system suggests a size but allows the shopper a choice to go up or down in size to account for individual fit preferences. In one or more embodiments, downstream fit-to-fit (shopper-to-manufacturer) matching measurements, threshold setting criteria and limits, manufacturer default rules, any modifications that the consumer may make in their preferences, and/or any modifications the manufacturer may make due to various changes such as manufacturing line re-tooling, supplier fabric changes, or relevant commodity price changes are stored in database 117. For example, a shopper may set their preference to round up to the next standard waist size, if their shopping avatar is between two standard manufacturer sizes.

In one or more embodiments described herein, family rules are parameterized and may be adjusted through shopper preferences or other means to tailor the search as tightly or loosely as a shopper desires. The intent is to make use of both search terms and the measurements of the relevant portions of the avatar to narrow the search results. In one or more embodiments, database 117 may store downstream data such as shopper preferences. For example, when selecting a t-shirt a shopper may express preferences (as collected via an online survey or other manner) such as wanting to round down to the next standard size, when the shopper's shopping avatar dimensions put them in between two standard manufacturer sizes. This preference can be grouped with one or more additional preferences (forming a family of preferences or “family rule”), that might, for example, say round down to the next nearest standard t-shirt size, but only if the shirt can still be tucked into the shopper's jeans (and thus the torso length dimension may override the rounding down preference, and supersede it, via a family rule in this instance, to round up to the next nearest standard size.

3D objects derived from measurable meshes and avatars are no different. There is a substantial body of literature on meshes for avatars. Furthermore it has been established that some few number of points from an avatar can capture the essential geometry of any portion of the avatar. In one or more embodiments, the combination of ranked parameters and algorithmic dimension matching may produce fit matching results that differ from a simple all-points dimensional matching process. For example, a male consumer buying a t-shirt may have previously expressed a preference (via an online survey or in another manner) for t-shirts that fit loosely, but must be able to be tucked into their jeans. Thus, such a shopper might not care, for example, if a particular t-shirt had an extra square inch of fabric in the armpit, but would care if the torso length were an inch too short (and thus not able to be tucked into the shopper's jeans). In such an instance, not all the dimensional data points for a shoppers shopping avatar are of equal importance, and some may be parameter ranked “low” or even excluded entirely. Thus, the essential geometry vis-a-vis any given shopper may be captured by a subset of the data points that completely describe a shoppers shopping avatar.

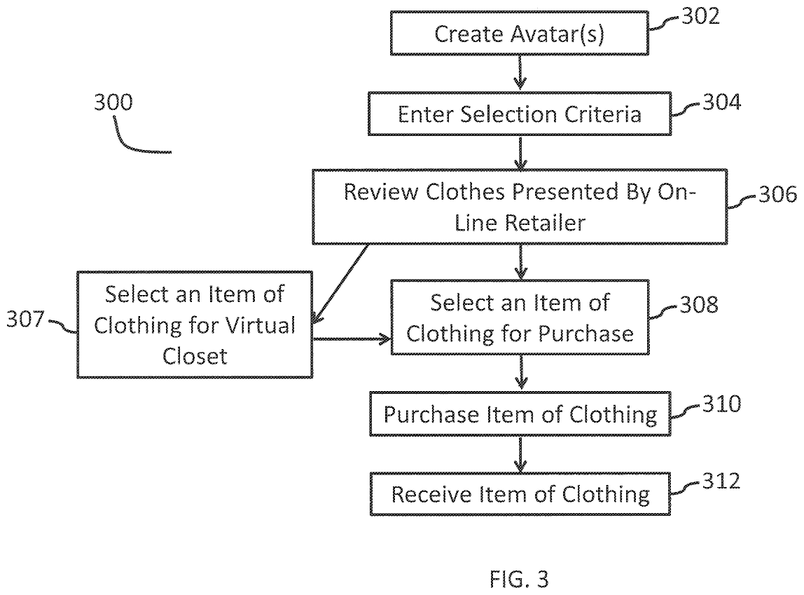

Turning now to FIG. 3, a flow diagram 300 of a consumer process for shopping is generally shown in accordance with one or more embodiments. At block 302, the shopper, or consumer, creates one or more 3D shopping avatars, and at block 304 enters selection criteria. The on-line shopping system returns a selection of clothes that meet the selection criteria and that are likely to fit the shopper, and at block 306 the consumer looks through the clothing selection. At block 308, the consumer selects an item of clothing for purchase, and at block 310 purchases the item of clothing using, for example Paypal or other on-line purchasing method. At block 312, the consumer receives the item of clothing by mail or by picking it up in a specified location. Optionally, at block 307, a shopper may store various clothing selections in an on-line virtual closet, for mixing and matching at a future date. The shopper can select the same item for purchase at block 308 and for storage in a virtual closet at block 307. The shopper can also select an item for purchase at block 308 that is not selected for storage in a virtual closet at block 308. In addition, the shopper can select an item for storage in a virtual closet at block 307 that is not selected for purchase at block 308.

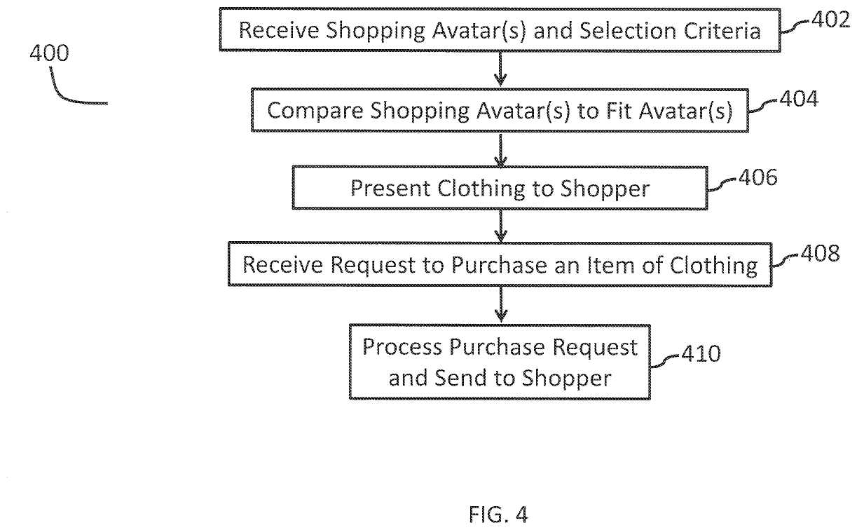

Turning now to FIG. 4, a flow diagram 400 of an on-line retailer process for shopping is generally shown in accordance with one or more embodiments. At block 402, the on-line retailer receives a shopping avatar(s) and one or more selection criteria from a consumer. At block 404, the on-line retailer performs a process such as that described in reference to FIG. 1 or FIG. 2 to identify what clothing to present to the shopper based on the selection criteria and by comparing the shopping avatar(s) to the fit avatar(s). At block 406, the identified clothing is presented to the shopper and at block 408, the on-line retailer receives a request from the consumer to purchase an item of clothing. At block 410, the purchase request is processed and the item of clothing is sent to the shopper. The item of clothing can be already made and sent to the consumer, or it can be manufactured based on the purchase request and then sent to the consumer.

It should be appreciated that while embodiments herein describe shopping for clothing, this is for exemplary purposes only and the claimed invention should not be so limited. In other embodiments, the consumer is shopping for any merchandise capable of being worn on a human body, such as but not limited to purses, hats, shoes, jewelry (e.g., rings, necklaces, bracelets), body art (e.g., tattoos), watches, and any other items capable of surrounding or penetrating the body. In addition, the 3D fit avatar does not have to be a full body avatar for items that do not cover the whole body. For example, a 3D fit avatar for a ring may include only a hand or only a finger, or even be represented by a geometrically cylindrical, or other, shaped object. The shopping avatar can include all or a portion (e.g., just the hand or finger) of the consumer's body with the relevant portion of the shopping avatar identified and used for matching, and optionally used for display to the consumer.

In one or more embodiments, the avatars are a soft tissue, which mimics the flesh of a live human being, and items can be added that shape a soft tissue avatar (e.g., bras, Spanx®). A reshaped shopping avatar can be compared to the fit avatars. When considering multi-layer garments, embodiments can adjust the fit avatar by adding equivalent layers in order make the match as realistic as possible.

In one or more embodiments, where fit avatars are not available, existing clothing can be placed on mannequins or live human fit models that are scanned to create the avatar fit models. A large number of mannequins can be purchased, or fit models' services contracted for, across the human body size spectrum and the clothes physically tried on the mannequins, or live human fit models, until a “best fit” is found. The aforementioned enables the search methodology described herein to point consumers towards items that are in their size and then have them evaluate the 2D images thereof.

One or more embodiments provide a novel process of matching a shopper's fit avatar measurement data against a database containing the actual 3D fit model measurement data utilized by various manufacturers to manufacture a specific garment, and therefrom return a suggested result (e.g. an item of clothing) which is more accurate than contemporary matching methods which include 2D and 3D methods, but are not specific to the actual manufacturing CAD/CAM data utilized to produce/manufacture a given item of clothing. One or more embodiments obviate the need for shoppers to rely upon the arbitrary, non-standard, and widely varying clothing sizes (i.e., a size 12 dress from one manufacturer, might be a size 14 dress from another manufacturer). In addition, one or more embodiments, when compared to contemporary approaches, provide a presentation to the shopper of a far more accurate visual modeling of any particular piece of clothing, including, but not limited to unprecedented and novel in-motion renderings of how a garment would “flow” on a shopper's body as the shopper walks, dances, bends over, etc. In addition, one or more embodiments provide support for boutique mom-and-pop clothing manufacturers to be on par with global clothing makers, because fit-to-fit database-matched results are presented to the user, irrespective of brand equity.

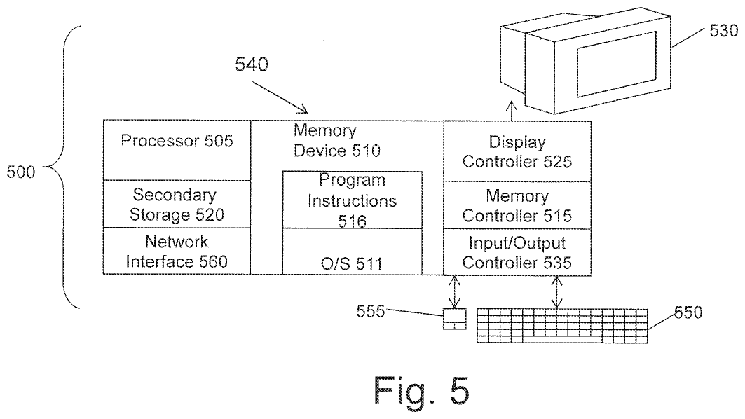

Turning now to FIG. 5, a block diagram of a system for avatar matching in on-line shopping is generally shown in accordance with one or more embodiments. In an embodiment, the system may be incorporated into the metrology device used to acquire the point cloud data. In one or more exemplary embodiments, in terms of hardware architecture, as shown in FIG. 5, the computer 501 includes a processing device 505 and a memory device 510 coupled to a memory controller 515 and an input/output controller 535. The input/output controller 535 can be, for example, but not limited to, one or more buses or other wired or wireless connections, as is known in the art. The input/output controller 535 may have additional elements, which are omitted for simplicity, such as controllers, buffers (caches), drivers, repeaters, and receivers, to enable communications. Further, the computer 501 may include address, control, and/or data connections to enable appropriate communications among the aforementioned components.

In one or more exemplary embodiments, a keyboard 550 and mouse 555 or similar devices can be coupled to the input/output controller 535. Alternatively, input may be received via a touch-sensitive or motion sensitive interface (not depicted). The computer 501 can further include a display controller 525 coupled to a display 530.

The processing device 505 is a hardware device for executing software, particularly software stored in secondary storage 520 or memory device 510. The processing device 505 can be any custom made or commercially available computer processor, a central processing unit (CPU), an auxiliary processor among several processors associated with the computer 501, a semiconductor-based microprocessor (in the form of a microchip or chip set), a macro-processor, or generally any device for executing instructions.

The memory device 510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory device 510 may incorporate electronic, magnetic, optical, and/or other types of storage media. Accordingly, the memory device 510 is an example of a tangible computer readable storage medium 540 upon which instructions executable by the processing device 505 may be embodied as a computer program product. The memory device 510 can have a distributed architecture, where various components are situated remote from one another, but can be accessed by the processing device 505.

The instructions in memory device 510 may include one or more separate programs, each of which comprises an ordered listing of executable instructions for implementing logical functions. In the example of FIG. 5, the instructions in the memory device 510 include a suitable operating system (OS) 511 and program instructions 516. The operating system 511 essentially controls the execution of other computer programs and provides scheduling, input-output control, file and data management, memory management, and communication control and related services. When the computer 501 is in operation, the processing device 505 is configured to execute instructions stored within the memory device 510, to communicate data to and from the memory device 510, and to generally control operations of the computer 501 pursuant to the instructions. Examples of program instructions 516 can include instructions to implement the processing described herein in reference to FIGS. 1-4.

The computer 501 of FIG. 5 also includes a network interface 560 that can establish communication channels with one or more other computer systems via one or more network links. The network interface 560 can support wired and/or wireless communication protocols known in the art. For example, when embodied in a user system, the network interface 560 can establish communication channels with an application server.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein. The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

What is claimed is:

1. A computer-implemented method comprising:
receiving selection criteria from a shopper;
identifying a shopping avatar of the shopper;
identifying relevant portions of the shopping avatar based on the selection criteria;
locating a fit avatar that includes portions corresponding to the relevant portions of the shopping avatar that are within a threshold of matching the relevant portions of the shopping avatar;
identifying merchandise items that were designed or manufactured based on the fit avatar;
presenting at least a subset of the identified merchandise items to the shopper, the subset including the identified merchandise items that satisfy the selection criteria;
receiving a request to purchase at least one of the subset of the identified merchandise items;
processing the request; and
sending the at least one of the subset of the identified merchandise items to the shopper.

2. The method of claim 1, wherein the merchandise items include clothing.

3. The method of claim 1, wherein locating a fit avatar that includes portions corresponding to the relevant portions of the shopping avatar that are within a threshold of matching the relevant portions of the shopping avatar further comprises comparing the relevant portions of the shopping avatar with an equivalent relevant portions from a plurality of fit avatars.

4. The method of claim 1, wherein the locating the fit avatar is further based on at least one of a downstream fit-to-fit matching measurement, a manufacturer default rule, a manufacturer modification to a merchandise item due to a change in a manufacturing process.

5. The method of claim 1, wherein the selection criteria includes at least one or more of a color preference, a price range, or a fabric.

6. A system comprising:
a memory having computer readable instructions; and
a processor for executing the computer readable instructions, the computer readable instructions including:
receiving selection criteria from a shopper;
identifying a shopping avatar of the shopper;
identifying relevant portions of the shopping avatar based on the selection criteria;
locating a fit avatar that includes portions corresponding to the relevant portions of the shopping avatar that are within a threshold of matching the relevant portions of the shopping avatar;
identifying merchandise items that were designed or manufactured based on the fit avatar;
presenting at least a subset of the identified merchandise items to the shopper, the subset including the identified merchandise items that satisfy the selection criteria;
receiving a request to purchase at least one of the subset of the identified merchandise items;
processing the request; and
sending the at least one of the subset of the identified merchandise items to the shopper.

7. The system of claim 6, wherein the merchandise items include clothing.

8. The system of claim 6, wherein locating a fit avatar that includes portions corresponding to the relevant portions of the shopping avatar that are within a threshold of matching the relevant portions of the shopping avatar further comprises comparing the relevant portions of the shopping avatar with an equivalent relevant portions from a plurality of fit avatars.

9. The system of claim 6, wherein the locating the fit avatar is further based on at least one of a downstream fit-to-fit matching measurement, a manufacturer default rule, a manufacturer modification to a merchandise item due to a change in a manufacturing process.

10. The system of claim 6, wherein the selection criteria includes at least one or more of a color preference, a price range, or a fabric.

11. A computer program product comprising a computer readable storage medium having program instructions embodied therewith, the program instructions executable by processing circuitry to cause the processing circuitry to perform:
receiving selection criteria from a shopper;
identifying a shopping avatar of the shopper;
identifying relevant portions of the shopping avatar based on the selection criteria;
locating a fit avatar that includes portions corresponding to the relevant portions of the shopping avatar that are within a threshold of matching the relevant portions of the shopping avatar;
identifying merchandise items that were designed or manufactured based on the fit avatar;
presenting at least a subset of the identified merchandise items to the shopper, the subset including the identified merchandise items that satisfy the selection criteria;
receiving a request to purchase at least one of the subset of the identified merchandise items;
processing the request; and
sending the at least one of the subset of the identified merchandise items to the shopper.

12. The computer program product of claim 11, wherein the merchandise items include clothing.

13. The computer program product of claim 11, wherein locating a fit avatar that includes portions corresponding to the relevant portions of the shopping avatar that are within a threshold of matching the relevant portions of the shopping avatar further comprises comparing the relevant portions of the shopping avatar with an equivalent relevant portions from a plurality of fit avatars.

14. The computer program product of claim 11, wherein the locating the fit avatar is further based on at least one of a downstream fit-to-fit matching measurement, a manufacturer default rule, a manufacturer modification to a merchandise item due to a change in a manufacturing process.

15. The computer program product of claim 11, wherein the selection criteria includes at least one or more of a color preference, a price range, or a fabric.

16. A computer-implemented method comprising:
creating a shopping avatar for a user;
receiving selection criteria regarding a merchandise item for the user;
identifying a plurality of merchandise items that satisfy the selection criteria and that were designed or manufactured using fit avatars having relevant portions that are within a threshold of matching corresponding portions of the shopping avatar, the relevant portions selected based on the selection criteria;
viewing the merchandise items via a user interface of a computer;
based on selecting one or more of the merchandise items for purchase, purchasing the one or more selected merchandise items; and
based on selecting one or more of the merchandise items for storage in a virtual closet, storing a representation of the one or more merchandise items selected for storage in the virtual closet.

17. The computer-implemented method of claim 16, wherein the merchandise items include clothing.

18. The computer-implemented method of claim 16, wherein the identifying the plurality of merchandise items further comprises comparing the relevant portions of the shopping avatar with an equivalent relevant portions from a plurality of fit avatars.

19. The computer-implemented method of claim 16, wherein the identifying the plurality of merchandise items is further based on at least one of a downstream fit-to-fit matching measurement, a manufacturer default rule, a manufacturer modification to a merchandise item due to a change in a manufacturing process.

20. The computer-implemented method of claim 16, wherein the selection criteria includes at least one or more of a color preference, a price range, or a fabric.

21. A system comprising:
a memory having computer readable instructions; and
a processor for executing the computer readable instructions, the computer readable instructions including:
creating a shopping avatar for a user;
receiving selection criteria regarding a merchandise item for the user;
identifying a plurality of merchandise items that satisfy the selection criteria and that were designed or manufactured using fit avatars having relevant portions that are within a threshold of matching corresponding portions of the shopping avatar, the relevant portions selected based on the selection criteria;
viewing the merchandise items via a user interface of a computer;
based on selecting one or more of the merchandise items for purchase, purchasing the one or more selected merchandise items; and
based on selecting one or more of the merchandise items for storage in a virtual closet, storing a representation of the one or more merchandise items selected for storage in the virtual closet.

22. The system of claim 21, wherein the merchandise items include clothing.

23. The system of claim 21, wherein the identifying the plurality of merchandise items further comprises comparing the relevant portions of the shopping avatar with an equivalent relevant portions from a plurality of fit avatars.

24. The system of claim 21, wherein the identifying the plurality of merchandise items is further based on at least one of a downstream fit-to-fit matching measurement, a manufacturer default rule, a manufacturer modification to a merchandise item due to a change in a manufacturing process.

25. The system of claim 21, wherein the selection criteria includes at least one or more of a color preference, a price range, or a fabric.

26. A computer program product comprising a computer readable storage medium having program instructions embodied therewith, the program instructions executable by processing circuitry to cause the processing circuitry to perform:
creating a shopping avatar for a user;
receiving selection criteria regarding a merchandise item for the user;
identifying a plurality of merchandise items that satisfy the selection criteria and that were designed or manufactured using fit avatars having relevant portions that are within a threshold of matching corresponding portions of the shopping avatar, the relevant portions selected based on the selection criteria;
viewing the merchandise items via a user interface of a computer;
based on selecting one or more of the merchandise items for purchase, purchasing the one or more selected merchandise items; and
based on selecting one or more of the merchandise items for storage in a virtual closet, storing a representation of the one or more merchandise items selected for storage in the virtual closet.
